(19) United States
(12) Patent Application Publication
(10) Pub. No.: US 2015/0104577 A1
(43) Pub. Date: Apr. 16, 2015

(54) WHEEL PROTECTING PANEL

(71) Applicant: Matthew Darron DOYAL, Shreveport, LA (US)

(72) Inventor: Matthew Darron DOYAL, Shreveport, LA (US)

(21) Appl. No.: 14/469,929

(22) Filed: Aug. 27, 2014

Related U.S. Application Data
(60) Provisional application No. 61/889,267, filed on Oct. 10, 2013.

(51) Int. Cl. B05B 15/04

(52) U.S. Cl. CPC B05B 15/0487
USPC 427/284; 301/37.103; 301/37.104

(57) ABSTRACT

A wheel protector is provided. The wheel protector may be a substantially circular panel having a front surface, a rear surface and a rim. The wheel protector may be made plastic, paper, metal or any suitable material. The circumference of the rim is sized to be substantially the same as the circumference of a wheel. Therefore, the wheel protector may cover the wheel while a user is spraying tire dressing onto the tires of a vehicle.

### CROSS-REFERENCE TO RELATED APPLICATION

This application claims the benefit of priority of U.S. provisional application No. 61/889,267, filed Oct. 10, 2013, the contents of which are herein incorporated by reference.

### BACKGROUND OF THE INVENTION

The present invention relates to a wheel protecting panel and, more particularly, to a wheel protecting panel that protects wheels from tire dressing.

Tire dressing is a product applied to tires to make them look shiny, clean and new. Detailing shops and car enthusiasts use it regularly. Water-based dressing is milky white, slippery instead of sticky, and environmentally friendly. Most tire dressing products on the shelf at your local auto parts store will be solvent-based and water based. When applying tire dressing to the tire, overspray may get on the wheels, which dulls the shine of cleaned wheels. Therefore, the wheels may need to be cleaned again.

As can be seen, there is a need for a device protects wheels from tire protector.

### SUMMARY OF THE INVENTION

In one aspect of the present invention, a wheel protector comprises: a substantially circular panel comprising a front surface, a rear surface, and a rim, wherein the circumference of the rim is sized to be substantially the same as the circumference of a wheel.

In another aspect of the present invention, a method of protecting wheels from tire dressing comprises: providing a substantially circular panel; placing the panel in front of a wheel of a vehicle; and spraying a tire mounted to the wheel with tire dressing.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention;

FIG. 3 is a back perspective view of the present invention;

FIG. 4 is a front view of the present invention;

FIG. 5 is a back view of the present invention;

FIG. 6 is a side view of the present invention; and

FIG. 7 is a section view of the present invention, taken along line 7-7 in FIG. 5

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a cover for the wheel that is held over the wheel to prevent tire dressing overspray from getting on the wheel. When applying tire dressing to the tire, the overspray gets on the wheel and dulls the shine of the cleaned wheel which has to be re-cleaned. By holding my present invention over the wheel when applying a tire-dressing, the overspray is kept off the clean wheel and thereby preventing re-cleaning.

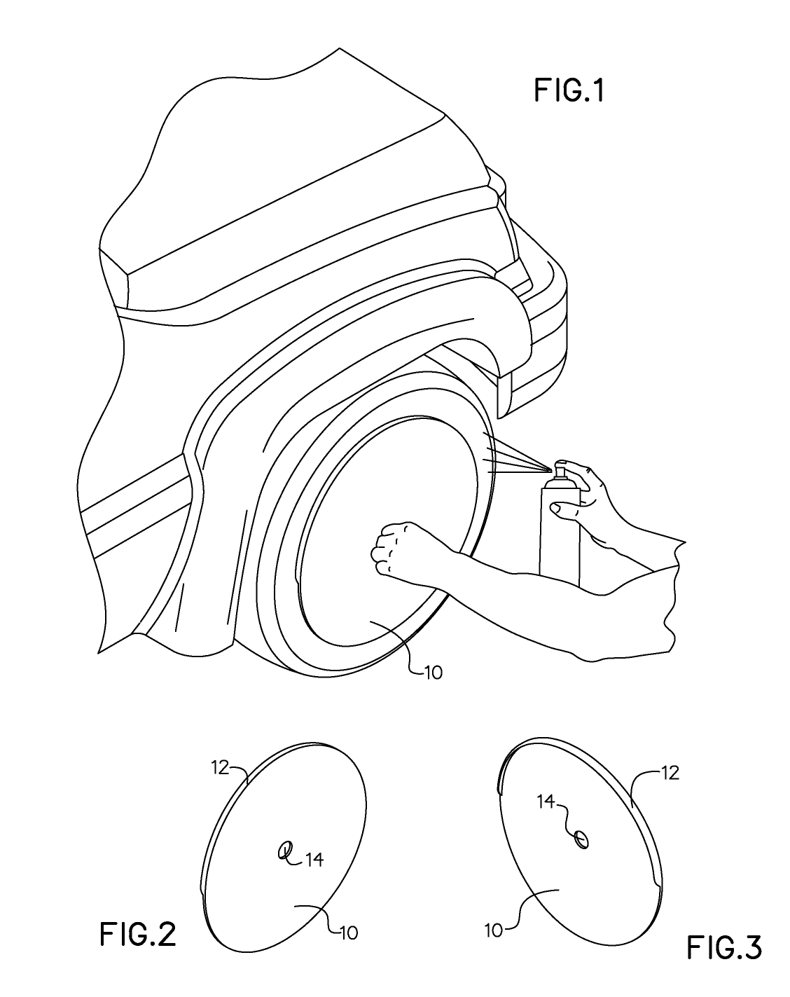

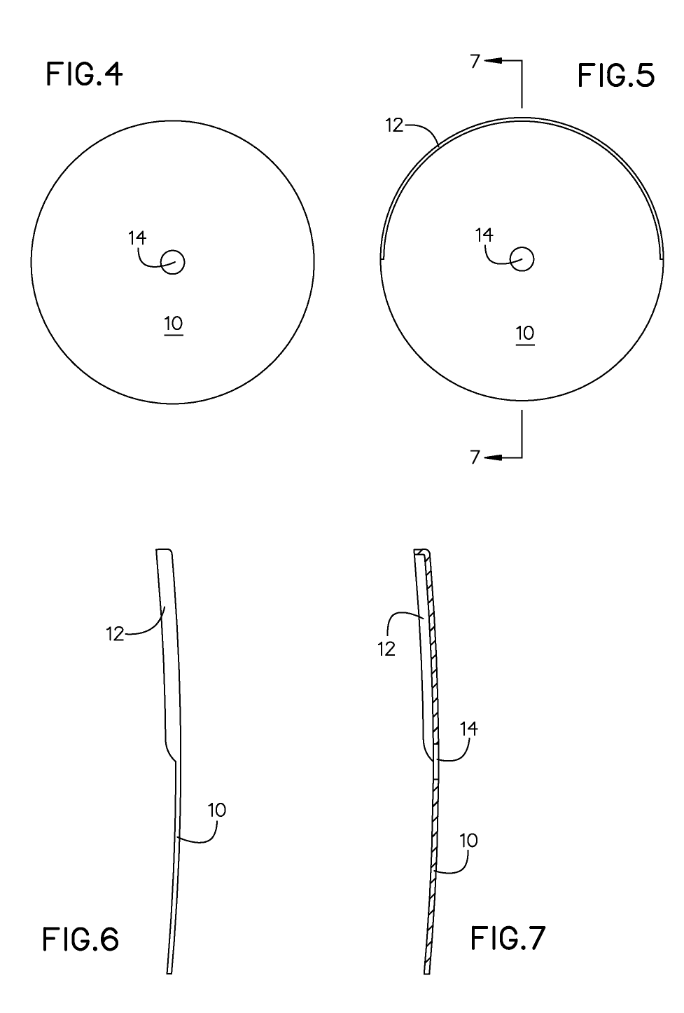

Referring to FIGS. 1 through 7, the present invention may include a wheel protector 10. The wheel protector 10 may be a substantially circular panel having a front surface, a rear surface and a rim. The wheel protector 10 may be made plastic, paper, metal or any suitable material. The circumference of the rim is sized to be substantially the same as the circumference of a wheel. Therefore, the wheel protector 10 may cover the wheel while a user is spraying tire dressing onto the tires of a vehicle.

In certain embodiments, the present invention may include a flange 12 that extends from the rear surface of the rim. The flange 12 may only extend from a portion of the rim or may extend from the entire rim. As illustrated in the Figures, the flange 12 may extend from about half of the rim. The flange 12 may be used to further protect the wheel from the tire dressing.

The present invention may further include a handle 14. The handle 14 may be disposed on the front surface of the panel. Therefore, a user may grasp the wheel protector 10 and place the wheel protector 10 in front of the wheel. In certain embodiments, the handle 14 may include an opening through the front and rear surface of the wheel protector 10. The opening may be near the center of the circular panel. Therefore, the user may grasp the wheel protector 10 using the opening.

The present invention may further include a method of protecting wheels from tire dressing. The vehicle's tire and wheel may first be cleaned. After cleaning the tire and the wheel, the method may include: providing a substantially circular panel; placing the panel in front of a wheel of a vehicle; and spraying a tire mounted to the wheel with tire dressing. As mentioned above, the panel may include a handle, such as an opening therethrough. Therefore, the method may further include the step of grasping the panel by the opening.

It should be understood, of course, that the foregoing relates to exemplary embodiments of the invention and that modifications may be made without departing from the spirit and scope of the invention as set forth in the following claims.

What is claimed is:

1. A wheel protector comprising:
a substantially circular panel comprising a front surface, a rear surface, and a rim, wherein the circumference of the rim is sized to be substantially the same as the circumference of a wheel.

2. The wheel protector of claim 1, further comprising a flange extending from a portion of the rear surface of the rim.

3. The wheel protector of claim 1, wherein the flange extending from about half of the rim.

4. The wheel protector of claim 1, further comprising a handle disposed on the front surface of the panel.

5. The wheel protector of claim 4, wherein the handle comprises an opening through the front surface and the rear surface, near a center of the circular panel.

6. A method of protecting wheels from tire dressing comprising:
providing a substantially circular panel;
placing the panel in front of a wheel of a vehicle; and
spraying a tire mounted to the wheel with tire dressing.

7. The method of claim 6, wherein the panel further comprises an opening therethrough.

8. The method of claim 7, further comprising the step of grasping the panel by the opening.
